(19) United States
(12) Patent Application Publication
(10) Pub. No.: US 2002/0012424 A1
(43) Pub. Date: Jan. 31, 2002

(54) Communication apparatus

(76) Inventors: Tatsuya Nishio, Nara-shi (JP); Keisuke Hasegawa, Soraku-gun (JP); Fumiaki Kobayashi, Yamatokoriyama-shi (JP)

Correspondence Address: NIXON & VANDERHYE P.C., 1100 North Glebe Rd., 8th Floor, Arlington, VA, 22201-4714, US

(21) Appl. No.: 09/904,864

(22) Filed: Jul. 16, 2001

(30) Foreign Application Priority Data
Jul. 18, 2000 (JP) 2000-217410
Jul. 19, 2000 (JP) 2000-218180

(51) Int. Cl. H04M 11/00; G06F 15/16

(52) U.S. Cl. 379/100.06; 709/206; 709/234; 709/217; 379/100.08

(57) ABSTRACT

In a communication apparatus, it is judged whether or not received data can be outputted from a memory device to the exterior. When the received data can be outputted, the data is outputted from the memory device to the exterior, while data reception is continued. When the data reception is completed, a delete signal is sent back to a server and the relevant data stored in the server is erased. When received data cannot be outputted from the memory device to the exterior, it is judged whether the amount of the data exceeds empty capacity of the memory or not. When it is judged that the memory device reaches a memory overflow condition, the delete signal is not transmitted, and a warning is given to a user, and line is disconnected. When the memory device recovers from the memory overflow condition, the server is automatically called, transmission of data is requested, and a routine is repeatedly performed until the reception of one case data is completed.

### BACKGROUND OF THE INVENTION

1. Field of the Invention

The present invention relates to a communication apparatus connected to the Internet and capable of receiving an electronic mail.

2. Description of the Related Art

In recent years, the electronic mail system that uses the Internet to transmit and receive mail data (electronic mail) has been increasingly popular. When a user desires to use the electronic mail system, the user accesses to a predetermined Internet service provider (hereinafter abbreviated as ISP), a vender who provides access to the Internet, using a communication apparatus, and then a connection to the Internet is established via a router administered by the ISP. The mail data transmitted and received via the Internet are temporarily stored in a server also administered by the ISP. Generally, by manually accessing the server, a user downloads the mail data on its own communication apparatus, so as to display or print them using the communication apparatus.

In the electronic mail system mentioned above, it is a well-known technique to send an electronic mail with an attachment such as an image read on a facsimile and a voice message, attached to the electronic mail. There are known terminal equipment other than personal computers (hereinafter called “PC”), which is designed so as to recognize Internet protocols and be accessible to Internet (e.g., an Internet facsimile apparatus (hereinafter called “I-FAX”)).

For example, Japanese Unexamined Patent Publications JP-A 5-347677 (1993) and JP-A 11-8721 (1999) disclose facsimile apparatuses comprising means for detecting an amount of remaining paper sheets, a computer network interface, and means for controlling transmission and reception of an electronic mail, wherein the amount of remaining paper sheets detected by the detecting means is notified via an electronic mail system, and in cases where stock paper runs out, unprinted data can be transmitted via the electronic mail system, or, as such, not only functioning as an ordinary facsimile apparatus, but the facsimile apparatus is also capable of transmitting data via the electronic mail system.

Further, Japanese Unexamined Patent Publication JP-A 11-65791 (1999) discloses a printing apparatus, which, in cases where the amount of printing data exceeds the capacity of a memory mounted on the printing apparatus, transfers the printing data to another printer having a larger memory capacity on the same local area network.

Japanese Unexamined Patent Publication JP-A 11-122227 (1999) discloses a method of information communication, in which, upon receiving a data acquisition request from an information communication terminal, a communication path between the terminal and the requested network server is established, and the server transmits requested information to the information communication terminal via the established communication path based on the request made, and in which, even when information reception on the information communication terminal is interrupted in the middle, reception is made possible again. In this case, the disclosed method comprises sending again to a server a request from the information communication terminal to provide information including the information already received on the information communication terminal.

Transmission of information such as voice message and image information using electronic mail via the Internet has been a generally-used method for information transmission. However, the volume of transmitted information is likely to exceed the memory capacity of a receiver terminal. In particular, in the case of receiving data such as a colored image, which requires a large memory capacity, a memory overflow condition often occurs due to low memory capacity.

In this case, it is inevitable to disconnect the receiver terminal from the established communication path, and interrupt the information reception. At the same time, it is necessary to quickly eliminate the trouble of memory overflow and re-establish the communication to receive the remaining information in an efficient method.

After eliminating the trouble of memory overflow, it is necessary to receive the remaining data. However, electronic mail data is usually transmitted on a case basis, and thus, it requires receiving all the data of the interrupted case, which causes problems such as duplication reception or printing of the same data, in cases where a portion of the data of the interrupted case is already stored or printed on the receiver apparatus.

### SUMMARY OF THE INVENTION

An object of the present invention is to provide a communication apparatus for, when the amount of data received by a receiver terminal exceeds the capacity of a memory device for storing the data and the memory device reaches a memory overflow condition, preventing data being received from being erased, easily making recovery of the memory device from the memory overflow condition, and receiving data which could not be received due to the memory overflow condition.

Another object of the invention is to provide a communication apparatus for, even when the amount of data received by a receiver terminal exceeds the capacity of a memory for storing the data and the memory reaches a memory overflow condition, preventing reprinting of data already printed or stored while data printing is smoothly carried out.

The invention provides a communication apparatus connected to a network, capable of transmitting and receiving an electronic mail, comprising:

memory means for storing received data; and

control means for controlling so that, when the memory means reaches a memory overflow condition during data reception, the communication apparatus is disconnected from a communication path and data received and stored in the memory means is processed, and when the memory means recovers from the memory overflow condition and a free area is formed in the memory means, a transmission side is automatically called for the communication apparatus to restart the data reception.

In accordance with this invention, when a large amount of data such as a voice message, an image, etc. is electrically sent to a terminal unit by performing connection to the network such as the Internet, etc. and utilizing electronic mail, and the memory means of the terminal unit becomes insufficient (memory overflow) in capacity and all the data cannot be received, communication is restarted and subsequent data is automatically taken in when the memory means recovers from the memory overflow condition. Accordingly, all data can be received without bearing a burden on a user.

In the invention it is preferable that the communication apparatus further comprises notifying means for, when the memory means reaches the memory overflow condition, notifying the user of the memory overflow condition by a voice message or a display, so as to make recovery of the memory means from the memory overflow condition.

In accordance with the invention, when the memory means reaches the memory overflow condition, the user is notified of the memory overflow condition by a voice message or a display. Accordingly, the user can recognize that the memory means is in the memory overflow condition. Therefore, the memory recovers from the memory overflow condition by erasing data stored in the memory means, etc. on the basis of the notification.

In the invention it is preferable that when the memory means for storing received data reaches the memory overflow condition and the communication apparatus is disconnected from the communication path, a delete signal for erasing the relevant data stored in a server as a transmission side is not sent.

In accordance with the invention, when the memory capacity of the memory means becomes insufficient and the communication apparatus is disconnected from the communication path during the data reception, the relevant data stored in the server of the transmission side is not erased. Accordingly, the data can be stored in the server.

In the invention it is preferable that when data is not provided because of busyness or the like as calling results of a rerequest of data, recalling is repeatedly performed with predetermined timing.

In accordance with the invention, when the rerequest of data is called and data cannot be received because of busyness of a line, the recalling is automatically repeatedly performed so that it is not necessary to manually perform the recalling.

The invention provides a communication apparatus connected to a network, capable of transmitting and receiving an electronic mail, comprising:

memory means for storing received data;

printing means for printing the received data on a recording sheet; and

control means for controlling so that, when the memory means reaches an overflow condition during data reception, the data reception is interrupted and the data stored in the memory means is erased in cases where the data stored in the memory means is not printed on a recording sheet, and

when data reception is restarted, received data is stored in the memory means, and the stored data in the memory means is read out to print on a recording sheet by the printing means.

In accordance with the invention, when the reception of data through the network is interrupted and data stored in the memory means by the data reception is not printed on the recording sheet, the data stored in the memory means is erased. Thereafter, when the reception of data through the network is restarted, the data stored in the memory means by the data reception is printed on the recording sheet. Therefore, when one portion of data being received is already stored in the memory means, reprinting of the data already stored can be prevented. Accordingly, useless consumption of the recording sheet and power can be prevented.

In the invention it is preferable that the control means controls so that, when the data reception is interrupted, and the data stored in the memory means by the data reception is printed on the recording sheet, a data portion printed on a recording sheet by the printing means is stored in the memory, and when data reception is restarted, the data stored in the memory means by the data reception is compared with data already stored in the memory means and data except for the data portion already printed on the recording sheet on the recording sheet is printed on a recording sheet.

In accordance with the invention, a data portion printed on the recording sheet is stored when the reception of data through the network is interrupted and the data stored in the memory means by the data reception is printed on the recording sheet. Thereafter, when the reception of data through the network is restarted, the data stored in the memory means by the data reception and data already stored in the memory means are compared with each other, and data except for the data portion already printed on the recording sheet is printed on the recording sheet. Thus, when one portion of data being received is already printed and is stored in the memory means, reprinting of the data already printed or stored can be prevented.

The invention also provides a communication apparatus connected to a network, capable of transmitting and receiving an electronic mail, comprising:

memory means for storing received data;

printing means for printing the received data on a recording sheet; and

control means for controlling so that, when the memory means reaches a memory overflow condition during data reception, the data reception is interrupted and a data portion printed on a recording sheet by the printing means among data stored in the memory means by the data reception is stored, and when data reception is restarted, the data stored in the memory means by the data reception is compared with data already stored in the memory means, and data except for the data portion already printed on the recording sheet is printed on a recording sheet by the printing means.

In accordance with the invention, when the reception of data through the network is interrupted, the data portion printed on the recording sheet among the data stored in the memory means by the data reception is stored. Thereafter, when the reception of data through the network is restarted, the data stored in the memory means by the data reception and the data already stored in the memory means are compared with each other, and data except for the data portion already printed on the recording sheet is printed on the recording sheet. Thus, when one portion of data being received is already printed, reprinting of the data already printed can be prevented. Accordingly, useless consumption of the recording sheet and power can be prevented.

In the invention it is preferable that the control means controls so that when the memory overflow condition is caused during the data reception, the data reception is interrupted, and when the memory recovers from the memory overflow condition, data reception is restarted.

In accordance with the invention, the data reception is interrupted when the memory overflow condition is caused during the data reception, and the data reception is restarted when the memory recovers from the memory overflow condition. Thus, data received through the network can be smoothly printed on the recording sheet without requiring a complicated operation of a user.

### BRIEF DESCRIPTION OF THE DRAWINGS

Other and further objects, features, and advantages of the invention will be more explicit from the following detailed description taken with reference to the drawings wherein:

FIG. 1 is a block diagram showing a configuration of an I-fax as an embodiment of the invention;

FIG. 2 is a diagram showing an example of methods of connecting I-faxes of the embodiment of the invention;

FIG. 3 is a flow chart showing an operation flow in the Internet facsimile apparatus of FIG. 1 during data reception;

FIG. 4 is a flowchart showing operation flow in an Internet facsimile apparatus in another embodiment of the invention during data reception; and

FIGS. 5A and 5B illustrate examples of electronic mail received on the Internet facsimile apparatus.

### DETAILED DESCRIPTION OF THE PREFERRED EMBODIMENTS

Now referring to the drawings, preferred embodiments of the invention are described below.

The invention can be applied to a communication apparatus, such as a facsimile and the like, connected to a communication network such as the Internet, and receiving data such as image, voice message or text using electronic mail. Here, the invention is explained with respect to an Internet-accessible facsimile apparatus (hereinafter, I-fax) as an example.

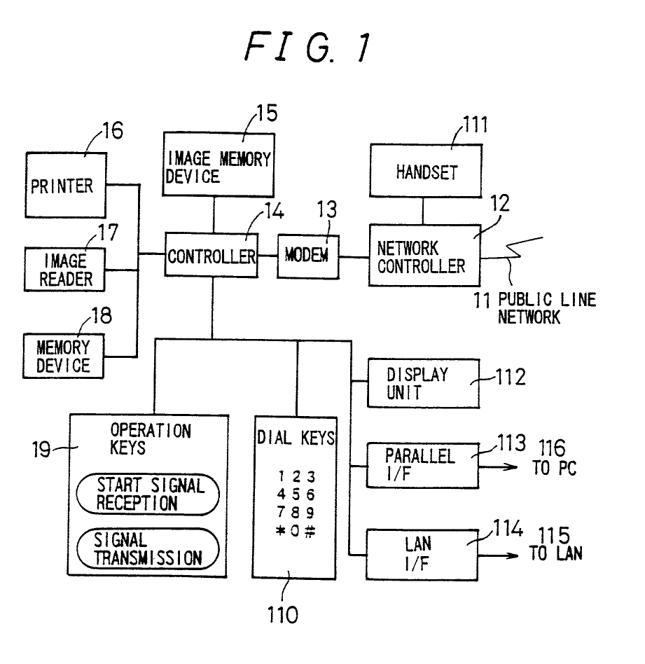

FIG. 1 is a block diagram showing a configuration of an I-fax as an embodiment of the invention.

The I-fax in the embodiment is connected to a public line network 11 such as a telephone line network, etc. using a network controller 12.

The network controller 12 monitors the condition of the public line network 11, and switches the connection with the line to a modem 13 or to a handset 111.

The modem 13 performs modulation of digital signals of image data to analog signals to be suitable to the public line network 11 and demodulation of analog signals received via the public line network 11 to digital signals to be printable. The handset 111 collects and emits, in accordance with voice signals, sounds to be transmitted or received via the public line network 11.

An image reader 17 is for reading an image on a document in order to perform facsimile transmission, to create e-mail attachment files, or to make a photocopy. A reduction reading system using a combination of a lens and a CCD (Charge Coupled Device) line sensor, a close contact sensor system using a rod lens array and the like is used to read a document.

An image memory device 15 is a unit for storing image data read by the image reader 17 and image data demodulated by the modem 13. With the unit, it becomes possible to achieve various kinds of complicated functions, e.g., transfer of received image, multiple address transmission, memory proxy reception when stock paper runs out, memory transmission and so on.

A printer 16 is a unit for printing an image on a recording sheet, as a result of demodulation by the modem 13, image read by the image reader 17 or the image read out from the image memory device 15. The printer 16 may be of a thermal system, an electrophotographic system, an inkjet system and the like. In this embodiment, paper is used as the recording sheet.

A controller 14 determines, in cooperation with a program stored in the memory device 18 and based on data such as those inputted using operation keys 19 or dial keys 110, those concerning the state of the devices or those of signals received from the public line network 11, a suitable operation-to-be for the entire device, gives instructions to the entire device and gives display instructions to a display unit 112. Further, the controller 14 performs compression processing of image data for reducing a transmission time, and expansion processing for restoring compressed image signals to original pixel data.

The operation keys 19 and the dial keys 110 are for inputting data and instructions to the device by a user. With these keys, functions of the facsimile apparatus are turned on and off, and telephone numbers are inputted as well.

The display unit 112 is a unit for displaying information as a user interface such as giving operation directions to use the facsimile apparatus. For example, a liquid crystal display unit is used as the display unit 112. The memory device 18 is a memory, a RAM for example, and stores data such as telephone directory, etc., in addition to controlling programs.

The I-fax in this embodiment has, in addition to the network controller 12 as an interface with the public line network 11, another two kinds of interfaces that allow a connection to the Internet.

A parallel I/F 113 is an interface with a personal computer (PC) 116. In this embodiment, the parallel I/F 113 is used as the interface to the PC 116, but the interface is not necessarily a parallel interface. A LAN I/F 114 is used as an interface to a LAN circuit network 115.

As mentioned above, in the facsimile apparatus in the embodiment, three kinds of interfaces to external devices are provided. Therefore, in a typical using condition, the facsimile apparatus performs an ordinary facsimile transmission or reception using an interface to the publics line network 11 and establishes communication to the Internet using either of the remaining two interfaces. However, it is also possible that the public line network 11 is utilized for an ordinary facsimile transmission and for a communication with a server via a LAN or the Internet; in short, all connections can be established via the public line network 11.

These three kinds of interfaces are provided merely as a typical connecting means for an apparatus accessible to the Internet, and thus it is not necessary to include all of these interfaces.

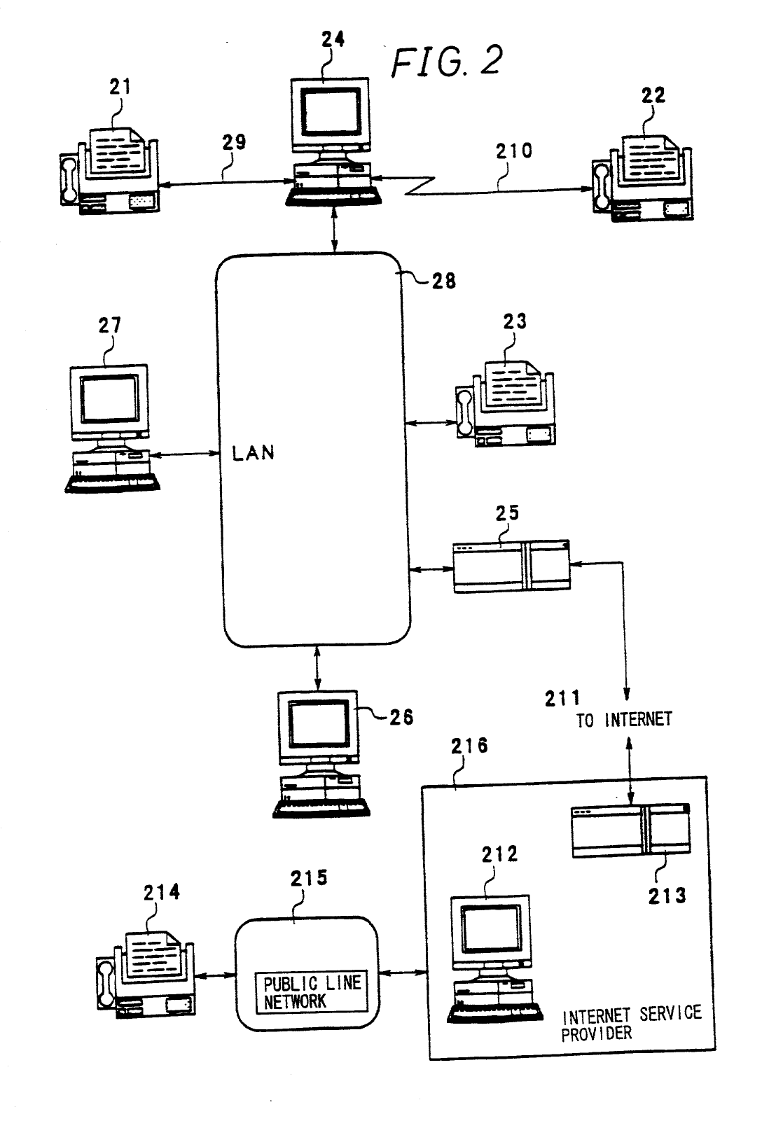

FIG. 2 is a diagram showing an example of methods of connecting I-faxes of the embodiment of the invention.

In FIG. 2, a connection to the Internet 211 is established using a corporate LAN (Local Area Network) 28 which is a networking system often used in a business situation. The diagram also illustrates a method of connecting an I-fax with the Internet 211 via an Internet service provider (ISP) 216 which is often used by a private user. Communication apparatuses shown by reference numerals 21, 22, 23 and 214 in FIG. 2 are I-faxes of the embodiment.

The following explanation is with respect to cases where an I-fax is connected to the Internet 211 via the LAN 28. Client terminals such as computers 26 and 27 are connected to the LAN 28. The LAN 28 is connected to the Internet 211 via a router 25.

Further, to the LAN 28, a server computer 24 is connected. The server computer 24 administers client computers on the LAN 28, and data such as text, facsimile transmitted image and sounds received via the Internet are stored temporarily in the server computer 24 for the client computers.

The I-fax 21 is directly connected to the server computer 24 using a cable 29. However, in cases where the protocol used between the I-fax 21 and the server computer 24 is of a less complex level, the invention may not be applicable. In this case, the parallel I/F 113 of FIG. 1 can interface another PC (not shown) with the cable 29, so that a connection to the LAN 28 from an I-fax may also be performed via a PC.

Further, the I-fax 22 can be connected to the server computer 24 either via a telephone line or via an ISDN line network 210. The Internet facsimile 22 is capable of recognizing protocols such as TCP/IP and generating signals so as to communicate with the server computer 24 using the on-line network. Voice communication can be carried out by establishing a connection via a public phone line (it can be ISDN, too) 11 (not shown) using the network controller 12 shown in FIG. 1.

The I-fax 23 is directly connected to the LAN 28. In this case, the I-fax 28 is connected to the LAN 28 using the LAN I/F 114 shown in FIG. 1.

The invention can be worked by using any one of the above connecting methods.

Each of the above connecting methods is merely an example of a configuration in which the I-fax is connected to the Internet 211. Accordingly, a connection of the I-fax of the invention to the Internet 211 is not restricted to the above example.

Further, another I-fax 214 is connected to the Internet with a method normally used by an individual user. In this case, a user subscribes a connection from an ISP 216, a vender who provides access to the Internet, and makes an access to the ISP 216 through a public line network 215, such as a telephone line network, an ISDN line network and the like.

A server 212 administered by the ISP 216 stores data with respect to transmission and reception with a terminal equipment (e.g., the facsimile apparatus 214), and establishes connection with the Internet 211 via a router 213. Then, the ISP 216 transmits data to the Internet 211, or receives data from the Internet 211.

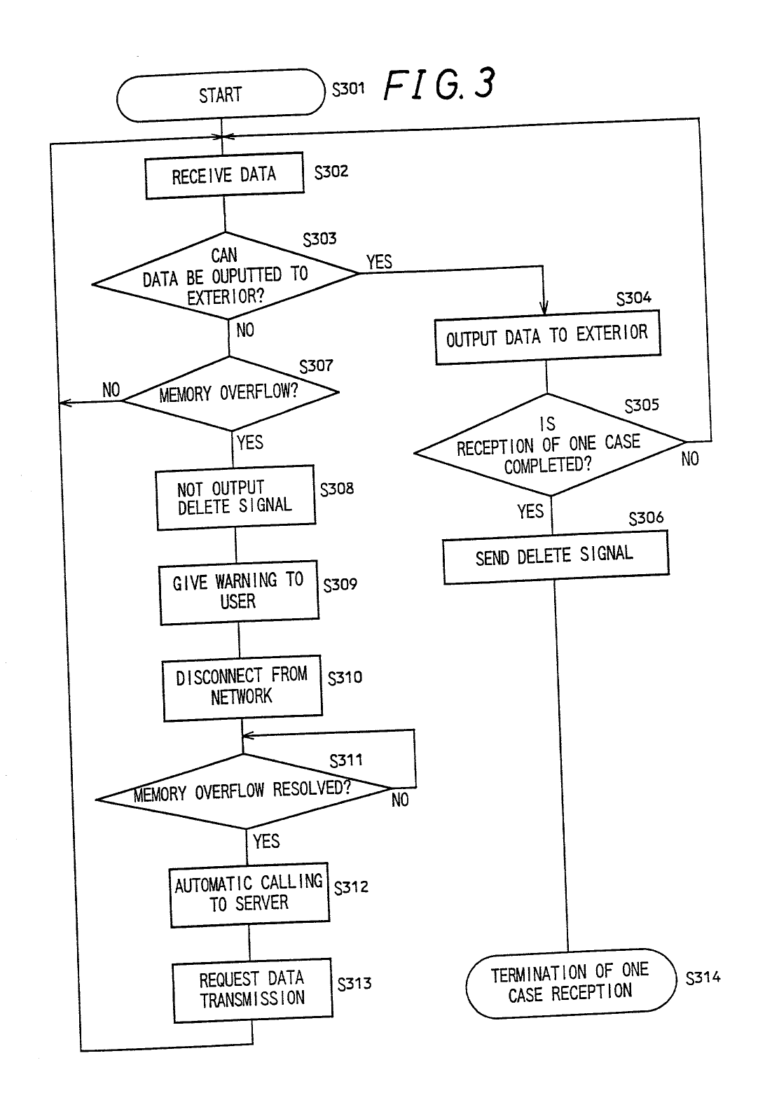

FIG. 3 is a flow chart showing an operation flow in the facsimile apparatus of the embodiment during data reception. Here, connection with the ISP 216 is established via the public line network 215 either by the user's manual calling or by automatic calling, in order to receive electronic mail addressed to the number of the facsimile apparatus and stored in the server computer 212 of the ISP 216.

Upon establishing connection with the ISP 216, reception of one case data is started (step S301) using the TCP/IP protocol. In this case, the user's manual calling means any calling operation by any user, while the automatic calling means a periodic calling made on the basis of data such as an appropriate calling time or interval and a target number.

Information such as an image and a voice message, is attached to electronic mail using MIME (Multipurpose Internet Mail Extensions) and the like.

Upon receiving data (step S302), received data are sequentially checked for a judgment in terms of whether or not the data can be outputted from the memory device 18 by transferring to another medium or to a printer 16 (step S303).

In cases where it is judged that the data can be outputted, the data are outputted from the memory device 18 to the exterior (step S304). Then, it is judged whether or not the reception of one case data is completed (step S304). When the judgment turns out NO, it is returned to step S302 and the data reception is continued until the reception of one case data is completed. When the reception of one case data is completed, a delete signal which is for erasing data just transmitted from the server is sent back to the server (step S306), and the operation is terminated (step S314).

Further, in cases where there are data yet to receive, the operation returns to the beginning (step S301) to receive a new case data, and the same operation flow is repeatedly performed.

By contrast, in cases where it is judged in step S303 that data cannot be outputted, a subsequent judgement will begin to judge whether or not the volume of the data will exceed the allowable memory capacity of the memory device 18, i.e., whether or not there is a possibility of causing a memory overflow (step S307).

Then, in the case of judging that the received data exceeds the capacity of the memory and thus causing a memory overflow, it will not be sent the delete signal for erasing the data to the server (step S308), and a warning of the memory overflow is given to a user by means of displaying messages on the display device 112, emitting a voice message from a speaker (not shown) and the like (step S309), and then the connection is terminated (step S310). In this case, the data in the server is retained because “the delete signal is not transmitted” in step S308.

The memory device 18 condition is monitored with respect to capacity, and a judgment is made with respect to whether or not the memory device recovers from the memory overflow condition (step S311). When a free space is formed in the memory device 18 after the user's supply of recording paper for carrying on printing, transfer of the contents in the memory to another recording medium of the user or simply carrying on printing and so on, and the memory device recovers from the memory overflow condition, the operation proceeds to the next step S312.

When it is judged in step S311 that the memory device recovers from the memory overflow condition, calling to the computer server is automatically begun, in order to make a request for data transmission to the server computer (step S313). Thereafter, it is returned to step S302, and until the data reception of one case is completed, the same routine is repeatedly performed.

In step S312, in cases where an initial automatic calling fails, due to a busy line and the like, the same number will be called again at an appropriate interval.

In this case, when connection is not established after repeating the calling several times, the calling may be aborted and a warning message for the aborted operation may be given to the user.

On the other hand, in step S307, in cases where received data do not exceed the capacity of the memory and thus it is not causing a memory overflow, it is returned to step S302, so as to keep on receiving the data transmitted from the server until reception of one case data is completed.

As explained above, when a memory overflow is caused at a memory device during reception of data, the communication is automatically re-established to carry on data reception as soon as the memory device recovers from the memory overflow. Accordingly, all data can be received without bothering a user.

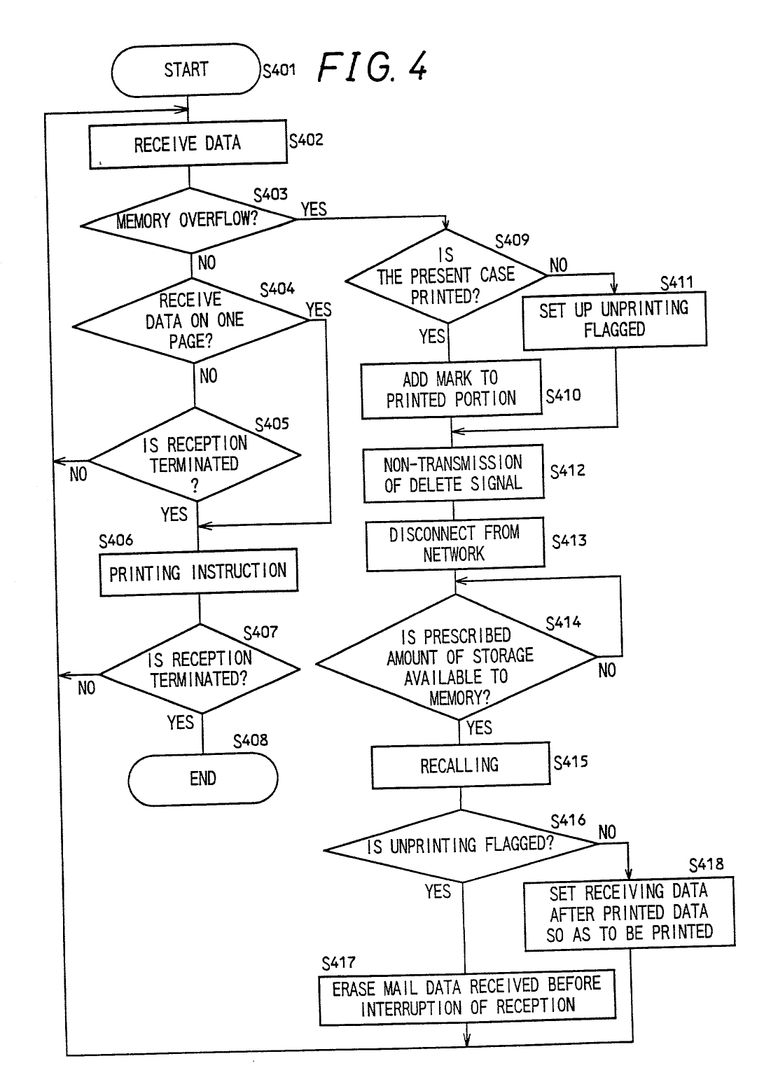

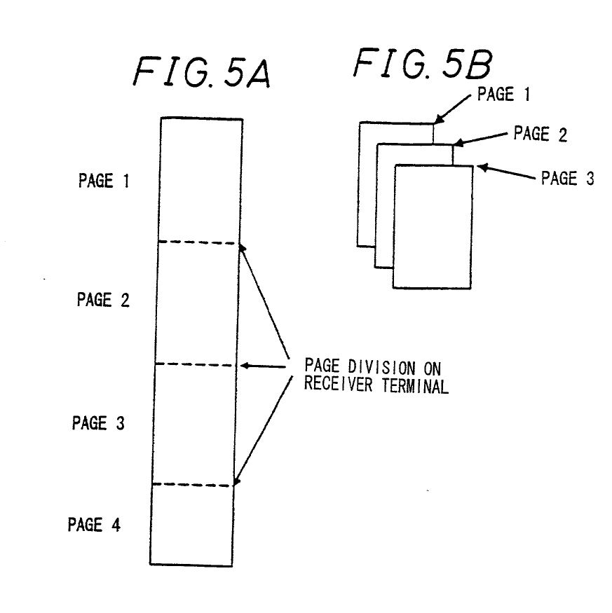

Next, another Internet facsimile apparatus (I-fax) as another embodiment of the invention will be explained. The I-fax of this embodiment has a construction similar to that of the I-fax in the above embodiment, and differs only by difference in processing operation during data reception. Operation of the I-fax in this embodiment during data reception will be explained on the basis of the flow chart shown in FIG. 4 and illustrations shown in FIGS. 5A and 5B. Here, the I-fax is connected to the ISP 216 via the public line network 215, and receives electronic mail addressed to the number of the I-fax and stored in the server computer 212 of the ISP 216.

A data receiving operation is started either by a user's manual calling or by an automatic calling (step S401).

When the calling is successful to establish a connection with the ISP, necessary operation to begin communication is carried out, and reception of electronic mail addressed to the number of the I-fax and stored in the server computer administered by the ISP is started (step S402). Meanwhile, it is judged whether or not the memory device 18 for storing electronic mail is in a memory overflow condition (step S403). When the memory device 18 is not in the memory overflow condition, subsequent judgments are carried out in order to judge whether or not the mail data received is of one page and whether or not the reception of the electronic mail is completed (steps S404 and S405).

When it is judged in step S404 that the electronic data of one page are received, or when it is judged in step S405 that the reception of the electronic mail is completed, an image based on the electronic mail stored in the memory device 18 is printed out by the printer 16 (step S406). Then, it is judged whether or not the reception of the electronic mail is completed (step 5407). When it is judged that reception of the electronic mail is not terminated, the above operations (steps S402 to S407) are repeatedly performed while continuing the data reception. On the other hand, when it is judged in step S407 that the reception of the electronic mail is completed, the operation of data reception is terminated (step S408).

In addition, there is a difference in data type among data received from the server computer 212 administered by the ISP 216, such as data having no page cutting code such as text data, long-reel data and the like as shown in FIG. 5A, and data divided for pages such as image data and the like attached to a text-type electronic mail as shown in FIG. 5B. When a separated sheet of paper is used as recording paper, it is necessary to print out on a page basis in any case. Therefore, the data having no page cutting code are to be divided in pages on a receiving side.

Further, while receiving the electronic mail addressed to the number of the I-fax transmitted from the server computer 212 administered by the ISP 216, in cases where it is judged in step S403 that the memory device 18 for storing the electronic mail is in a memory overflow condition, it is judged whether or not printing has been started with respect to the electronic mail of the respective case just received (step S409). When it is judged that printing has been started, a mark is added to the page among the received electronic mail for which printing is completed, so as to store the point to which the printing is completed (step S410). When printing has not been started, an unprinted flag is added to the electronic mail of one case which is just received (step S411).

Thereafter, without transmitting a delete signal to the server computer 212 administered by the ISP 216 (step S412), and thus the data is retained in the server computer 212, the connection with the public line network 215 is cut so as to terminate the communication with the server computer 212 administered by the ISP 216 (step S413).

Then, when an image generated based on the electronic mail stored in the memory device 18 is printed out by the printer 16 and is deleted as a result of an appropriate operation of a user and the like, so that an enough capacity in the memory device 18 is created (step S414), automatic recalling to an access point of the ISP 216 is performed (step S415) . When the calling is successful to establish a connection with the ISP, it is judged whether or not the unprinted flag is on (step S416) . When it is judged that the unprinted flag is on, the electronic mail, of which the reception is interrupted in the middle, is deleted (step S417). On the other hand, in cases where it is judged in the step S416 that unprinted flag is not on, the electronic mail received after the retry is compared with the stored electronicmail. Then, it is set such that a printing instruction excluding pages already printed, i.e., an instruction to begin printing from the top of unprinted part, is to be given (step S418). Thereafter, the operation proceeds to repeat the above-mentioned steps (steps S402 to S407) to receive data.

According to the above operation control, not only electronic mail received on the apparatus can be printed out promptly, but also duplication of printing operation can be prevented, in cases where data stored in the memory device 18 has not printed yet and reception of the data is interrupted in the middle, or where a part of data stored in the memory device 18 has already been printed.

In the above-explained embodiments, as a communication apparatus for printing data being received via the Internet 211 on recording paper, facsimile apparatus that is accessible to the Internet 212 via the server computer 212 administered by the ISP 216 and the public line network is explained. However, the invention is not restricted to the facsimile apparatus of embodiments, but can also be applied to a facsimile apparatus connected to the server computer 24 using the LAN 28 or directly connected to the server computer 24 using a cable. Further, it may be needles to say, but the invention can be extended to the use in other personal computers, multimedia communication apparatus and so on.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication apparatus connected to a network, capable of transmitting and receiving an electronic mail, comprising:
memory means for storing received data; and
control means for controlling so that, when the memory means reaches a memory overflow condition during data reception, the communication apparatus is disconnected from a communication path and data received and stored in the memory means is processed, and when the memory means recovers from the memory overflow condition and a free area is formed in the memory means, a transmission side is automatically called for the communication apparatus to restart the data reception.

2. The communication apparatus of claim 1, further comprising:
notifying means for, when the memory means reaches the memory overflow condition, notifying a user of the memory overflow condition by a voice message or a display, so as to make recovery of the memory means from the memory overflow condition.

3. The communication apparatus of claim 1, wherein when the memory means for storing received data reaches the memory overflow condition and the communication apparatus is disconnected from the communication path, a delete signal for erasing the relevant data stored in a server as a transmission side is sent.

4. The communication apparatus of claim 1, wherein when data is not provided because of busyness or the like as calling results of a rerequest of data, recalling is repeatedly performed with predetermined timing.

5. A communication apparatus connected to a network, capable of transmitting and receiving an electronic mail, comprising:
memory means for storing received data;
printing means for printing the received data on a recording sheet; and
control means for controlling so that, when the memory means reaches an overflow condition during data reception, the data reception is interrupted and the data stored in the memory means is erased in cases where the data stored in the memory means is not printed on a recording sheet, and
when data reception is restarted, received data is stored in the memory means, and the stored data in the memory means is read out to print on a recording sheet by the printing means.

6. The communication apparatus of claim 5, wherein the control means controls so that, when the data reception is interrupted, and the data stored in the memory means by the data reception is printed on the recording sheet, a data portion printed on a recording sheet by the printing means is stored in the memory, and when data reception is restarted, the data stored in the memory means by the data reception is compared with data already stored in the memory means and data except for the data portion already printed on the recording sheet on the recording sheet is printed on a recording sheet.

7. A communication apparatus connected to a network, capable of transmitting and receiving an electronic mail, comprising:
memory means for storing received data;
printing means for printing the received data on a recording sheet; and
control means for controlling so that, when the memory means reaches a memory overflow condition during data reception, the data reception is interrupted and a data portion printed on a recording sheet by the printing means among data stored in the memory means by the data reception is stored, and when data reception is restarted, the data stored in the memory means by the data reception is compared with data already stored in the memory means, and data except for the data portion already printed on the recording sheet is printed on a recording sheet by the printing means.

8. The communication apparatus of claim 5, where in the control means controls so that when the memory overflow condition of the memory means is caused during the data reception, the data reception is interrupted, and when the memory means recovers from the memory overflow condition, data reception is restarted.

9. The communication apparatus of claim 6, where in the control means controls so that when the memory overflow condition of the memory means is caused during the data reception, the data reception is interrupted, and when the memory means recovers from the memory overflow condition, data reception is restarted.

10. The communication apparatus of claim 7, wherein the control means controls so that when the memory overflow condition of the memory means is caused during the data reception, the data reception is interrupted, and when the memory means recovers from the memory overflow condition, data reception is restarted.
